(19) United States
(12) Patent Application Publication
(10) Pub. No.: US 2005/0242951 A1
(43) Pub. Date: Nov. 3, 2005

(54) Intrusion detection device for spaces

(75) Inventor: Giuseppe Simonazzi, Reggio Emilia (IT)

Correspondence Address: MODIANO & ASSOCIATI, Via Meravigli, 16, MILANO, 20123, IT

(73) Assignee: META SYSTEM S.P.A.

(21) Appl. No.: 11/111,906

(22) Filed: Apr. 22, 2005

(30) Foreign Application Priority Data
Apr. 30, 2004 (IT) MO2004A000094

(51) Int. Cl. G08B 13/18

(52) U.S. Cl. 340/552; 367/93

(57) ABSTRACT

A highly versatile intrusion detection device for spaces in general and for vehicles in particular, comprising at least one intrusion detection sensor of the ultrasound type with an asymmetric emission lobe that operates in echo mode.

The present invention relates to a highly versatile intrusion detection device for spaces. More particularly, the invention relates to an intrusion detection device for spaces in general and in particular for vehicles of any type, both convertible and sedan, that does not need to diversify the installed device.

### BACKGROUND OF THE INVENTION

As it is known, the growing number of thefts, particularly of cars, has induced most car manufacturers to install anti-theft systems directly at the factory or, if these systems are not already installed by the manufacturer, has forced substantially all users to install an anti-theft system after purchasing the vehicle.

Currently existing anti-theft systems for vehicles are divided into intrusion prevention systems, which are suitable to detect and indicate any intrusions into a controlled volume, and engine locking systems.

Different types of sensor, such as microwave or ultrasound sensors, are normally used in intrusion prevention systems.

Microwave sensors are complicated and expensive and also difficult to manage, since the waves are reflected by metallic objects and can cause false alarms.

Microwave systems are normally used for convertible vehicles.

In the case of closed vehicles, ultrasound systems are instead used which operate in an opposite mode, cannot be applied to convertible models and lose their effectiveness if the vehicle, despite being of the sedan type, has for example its windows lowered.

In all these situations, known ultrasound systems are in fact unsuitable, since they can detect movements that occur outside said vehicles.

### SUMMARY OF THE INVENTION

The aim of the present invention is to provide a highly versatile intrusion detection device for spaces and particularly for vehicles that can be used equally on convertible vehicles and on closed vehicles, since it is capable of detecting an intrusion into the region directly in the vicinity of the sensor that is used, ignoring what happens outside said region.

Within this aim, an object of the present invention is to provide an intrusion detection device that allows to reduce substantially to zero false alarms caused by incorrect sensing.

Another object of the present invention is to provide an intrusion detection device in which the sensors used are substantially insensitive to position variations of the internal parts of the space or vehicle cabin, such as for example adjustments of the seats or of the steering wheel.

Another object of the present invention is to provide an intrusion detection device that is highly reliable, relatively simple to provide and at competitive costs.

This aim and these and other objects that will become better apparent hereinafter are achieved by an intrusion detection device: for spaces, which comprises at least one intrusion detection sensor, characterized in that said at least one sensor is an ultrasound sensor with an asymmetric emission lobe that operates in echo mode.

### BRIEF DESCRIPTION OF THE DRAWINGS

Further characteristics and advantages of the invention will become better apparent from the following detailed description of a preferred but not exclusive embodiment of the device according to the present invention, illustrated by way of non-limiting example in the accompanying drawings, wherein:

FIG. 1 is a view of the intrusion detection device according to the present invention applied to a motor vehicle; and

FIG. 2 is a top plan view of the intrusion detection device according to the present invention shown in FIG. 1 together with the vehicle.

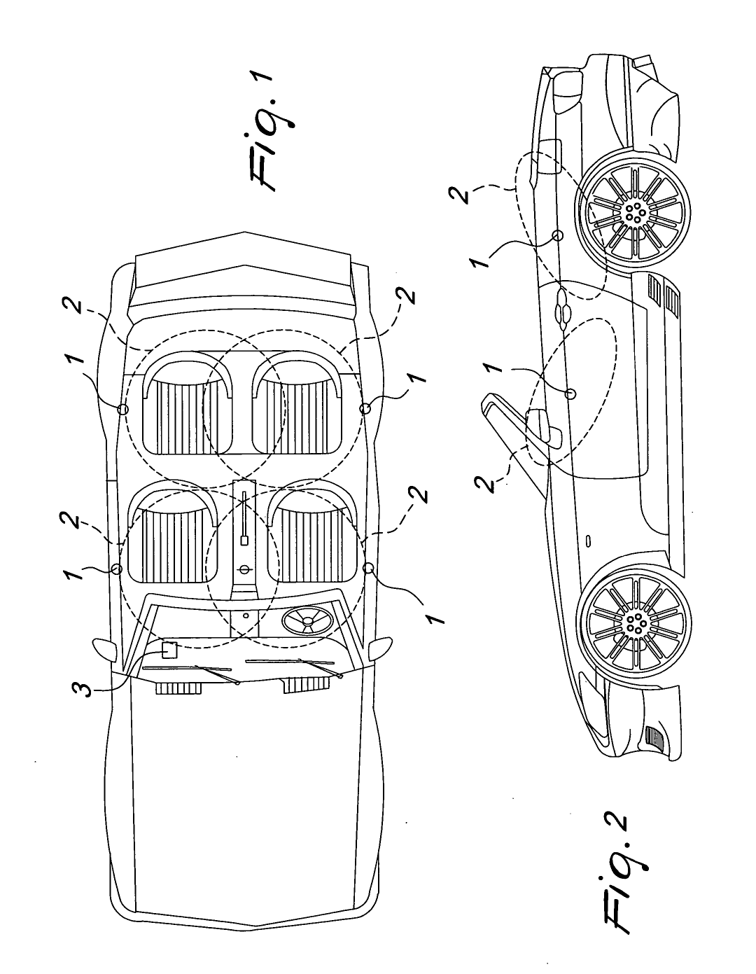

The device is illustrated and described with reference by way of example to a car. It is of course understood that the application can be extended without any modification to public or private spaces in general.

### DESCRIPTION OF THE PREFERRED EMBODIMENTS

With reference to the figures, an intrusion detection device for spaces in general and for vehicles in particular according to the invention comprises at least one sensor of the ultrasound type that is hermetic, has an asymmetric emission lobe, and is controlled and operates in echo mode.

Conveniently, there is a plurality of said sensors, which can be fixed to the doors, below the dashboard, to the posts of the windshield, et cetera. The sensors must be installed so that their emission surface faces the region to be protected.

The distribution of the sensors is variable according to the shape of the environment to be controlled.

The emissions surface is metallic, hermetic and easily adaptable to the type of vehicle interior.

The arrangement of the sensors is such as to allow the asymmetric sensing lobe to cover the maximum volume inside the vehicle without however leaving the perimeter of said vehicle.

The sensors are of the transceiver type.

In the figures, the sensors are designated by the reference numeral 1 and the associated lobes are shown in dashed lines and designated by the reference numeral 2.

Each sensor 1 is suitable to monitor a portion of the vehicle cabin and to emit, sequentially with respect to the other sensors, a brief ultrasound transmission.

Immediately after the transmission, the sensor is used in receive mode in order to detect the ultrasound echo signal that is reflected by the obstacles inside the vehicle.

Since sound has a predefined speed (on the order of 340 m/s), by analyzing the echo signal for a preset time interval it is possible to exclude from the analysis obstacles that are too distant from the sensors, since the reflection of the echo thereon is received with a delay that is longer than the delay that is preset for considering the echo as “useful”.

The echo signal related to the region to be protected, in the form of its envelope, is then completely stored by means of a microprocessor, schematically designated by the reference numeral 3 in the figures.

If no foreign object enters the protected region, the echoes received from periodic and successive transmissions have a stable and consistent form, indicating that no alarm has to be issued.

The repeat frequency of the echo monitoring should be high enough to detect even short-lasting intrusions.

If instead an object enters the protected region, the envelope of the received echo is altered and changes over time from one transmission to the next. These variations are evaluated by the microprocessor 3, which on the basis of a specific algorithm decides whether to issue or not signals indicating intrusions in progress, depending on, the type of variation and optionally on the correlation between the signals of all or some of the sensors 1.

The device thus provided is insensitive to variations in the position of the internal parts of the vehicle, such as for example to the adjustment of the position of the seats and/or of the steering wheel. When the system is activated, i.e., where the anti-theft system is armed, the device autonomously learns the current shapes of the echoes received by the various sensors and considers them as reference echoes for detecting intrusions.

Substantially, the acquired references are used to compare the subsequent echoes, so as to verify whether variations in the shape of the received echoes are occurring.

These references can in any case be slowly updated or corrected in order to allow the device to tolerate variations caused by external elements, such as temperature changes, wind, ultrasonic external noise, or others.

In practice, the device analyzes the received echo in order to compare it with at least one reference echo, so as to verify whether the difference between the detected echo and the reference echo lies within a preset value range; if the difference is not within said preset range, it issues an alarm signal, for example of the visual or acoustic type.

Echo analysis comprises analyzing the echoes received within a preset reception time, in order to verify whether the reception time exceeds a preset threshold.

The device can also be adapted to strong environmental variations simply by sending to each sensor the functional parameters, such as for example the echo analysis time that determines the depth of the protected region, when the device is activated.

The device provides the possibility to reduce the consumption of current absorbed by the battery by spreading out the echo verifications on each sensor 1 or by verifying its echoes with a reduced sampling or by performing the echo only on some of the sensors 1, which in this case operate with differentiated parameters (for example, it is possible to operate one sensor in the front part of the vehicle and one sensor in the rear part, with such a lobe depth as to cover the side that lies opposite to its fixing point).

If one of the sensors 1 detects a minimal variation, the system immediately returns to a detailed analysis of the signals in order to check for a possible intrusion.

Substantially, in this case, the power-save mode is abandoned in order to resume sampling at the normal rate.

All the sensors 1 can be connected to a single module, which contains an entire electronic circuit for driving the sensors and for analyzing the signals.

As an alternative, each sensor 1 can be provided with an electronic circuit, which receives the echo execution command from the central processing unit, which in turn receives information from the sensors regarding the characteristics of the received echoes. The bidirectional signal for communication between said control unit and the sensors 1 is of the logic and encoded type, so that a single connecting cable allows communication among all the components of the device.

In practice it has been found that the anti-theft device according to the present invention fully achieves the intended aim and objects stated above, since it allows to provide a volumetric protection of convertible and closed vehicles without having to differentiate the types of sensors as normally occurs with known types of anti-theft device.

The device thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. M02004A000094 from which this application claims priority are incorporated herein by reference.

1. An intrusion detection device for spaces, comprising at least one intrusion detection sensor, which is an ultrasound sensor with an asymmetric emission lobe that operates in echo mode.

2. The device of claim 1, wherein said at least one sensor is of a transceiver type.

3. The device of claim 1, further comprising a microprocessor-based control unit for controlling said at least one sensor and analyzing echoes received by said at least one sensor.

4. A method for detecting intrusion in spaces, comprising the steps of:
activating at least one ultrasound sensor provided in a space, said ultrasound sensor being provided of a type with an asymmetric emission lobe that operates in echo mode;
detecting an echo received by said at least one sensor and analyzing said echo in order to compare the echo with at least one reference echo, in order to check whether a difference between said detected echo and said reference echo is within a preset value range; and
when said difference is out of said preset value range, issuing an alarm signal.

5. The method of claim 4, comprising an initial step that consists of an autonomous learning step, performed by said at least one sensor, of current shapes of echoes received by said at least one sensor and of considering said shapes as reference echoes.

6. The method of claim 4, further comprising a step that consists in sending to said at least one sensor, functional parameters, in order to adapt operation of said at least one sensor, to environmental variations.

7. The method of claim 4, further comprising a step that consists in reducing current consumption of said at least one sensor by spreading out verifications of the echoes on said at least one sensor.

8. The method of claim 4, wherein said echo analysis comprises analyzing of echoes received within a preset reception time.
